(19) United States
(12) Patent Application Publication
(10) Pub. No.: US 2006/0117022 A1
(43) Pub. Date: Jun. 1, 2006

(54) Communication method and system using notification availability indicators

(76) Inventor: Matthew Paul Lucas, Romsey (GB)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/260,794

(22) Filed: Oct. 27, 2005

(30) Foreign Application Priority Data
Nov. 26, 2004 (GB) 0425996.6

(51) Int. Cl. G06F 17/30

(52) U.S. Cl. 707/10

(57) ABSTRACT

A communication method comprises generating a notification that includes a content portion and a notification availability indicator; transmitting the notification from a server to a client; and receiving the notification at the client. In one embodiment, the notification availability indicator includes a time value, indicating the likely time before another notification will be transmitted.

### FIELD OF THE INVENTION

The present invention relates to a communication method and to a communication system that uses notifications having notification availability indicators.

### BACKGROUND

In a computing system, it is common to designate devices or programs as clients and servers. Although the server and client will typically be two separate interconnected devices, the terminology can also be used to refer to the relationship between two programs or objects executed by a single machine. The server is the central unit in the relationship, communicating by sending notifications to one or more clients. Together, the server and clients form a communication system.

In object-oriented designs, a common algorithm employed is the observer design pattern. In this pattern, a one-to-many dependency between objects is defined so that when one object changes state, all its dependents are notified and updated automatically. For example, see “Design Patterns—Elements of Reusable Object-Oriented Software”, Gamma, Helm, Johnson, Vlissides, Addison Wesley 1995.

In this context, the term client is used to describe the function that requests notification of changes to an object, and the term server is used to describe the function that sends notifications to clients. Both of these terms can refer to complete applications or processes on the same or different machines, although they can also refer to objects that form part of a single application.

Typical usage of this pattern begins when a client calls a registration API which tells the server to keep it informed of any changes to a specified object. When the object then changes, the server calls a pre-defined function in the client which tells the client of the change. At this point, the client processes the change and returns control back to the server. The server then continues to notify any other clients, if necessary.

A graphical application (client) may use such an algorithm by registering for notifications to occur whenever an object being represented on screen is modified; the client may use this notification to refresh the relevant area of the screen. However, the client does not know when such notifications will occur, which can result in the client receiving many notifications in a short space of time, which will cause unnecessary screen updates and flickering.

One known solution is for the client to buffer requests; it will wait a set amount of time before acting on a notification to see if another notification arrives. This reduces the number of needless screen updates and flickering, but is quite inefficient if only one notification arrives. Further, it is not efficient for the server to group a set of notifications and send them in one batch, as it too does not necessarily know when updates are likely to occur, nor does it necessarily know which grouping of notifications would be most appropriate for the client.

### SUMMARY

According to a first aspect of the present invention, there is provided a communication method comprising generating a notification, the notification comprising a content portion and a notification availability indicator, transmitting the notification from a server to a client, and receiving the notification at the client.

According to a second aspect of the present invention, there is provided a communication system comprising a server and a client, the server comprising a processor arranged to generate a notification, the notification comprising a content portion and a notification availability indicator, and a communication interface for transmitting the notification to the client, the client comprising a communication interface for receiving the notification.

According to a third aspect of the present invention, there is provided a computer program product on a computer readable medium for controlling a communication system, the computer program product comprising instructions for generating a notification, the notification comprising a content portion and a notification availability indicator, for transmitting the notification from a server to a client, and for receiving the notification at the client.

Owing to the invention, it is possible to provide a communication method and server that will allow a server to notify a client in such a way that the client is able to decide if further notifications are likely to arrive within a timescale that will allow the client to adapt its updating strategy. The invention provides a method of notifying object observers so that they know roughly when the next update is going to occur. This is achieved by modifying the server to process notification requests asynchronously, and, in one embodiment, by using past performance information to estimate the time of the next notification. In a communication system, the method builds on the observer pattern in order to improve its efficiency in certain specific scenarios.

Preferably, the notification availability indicator comprises a time value. By communicating a time value indicating the likely time between notifications, the client can decide on the most efficient course of action. Alternatively, the notification availability indicator can comprise an indicator indicating that further notifications are to be transmitted, or the notification availability indicator can comprise an integer indicating the number of further notifications to be transmitted.

Ideally, the content portion comprises reference to a specific object, and the content portion includes an update request for the specific object.

Advantageously, the method further comprises receiving the object interest registration from a client. This allows any client to indicate to the server those objects for which they wish to be notified of any updates. Preferably, the object interest registration further includes a client identifier. This allows the server to identify the particular client that is interested in that object.

Ideally, the method further comprises receiving from the client an acknowledgement of receipt of the update request. By specifying that the server is to be notified when the client has received the update request, the server can be sure that the client has received the update request.

Advantageously, the method further comprises measuring the time taken from the updating of the client to the receipt of the acknowledgement of receipt of the update request, and storing the time taken with the client identifier. By measuring the time taken from the updating of the client to the acknowledgement by the client, it is possible to ascertain how long the client is taking to process the updates.

Preferably, the step of calculating the time value includes recalling the stored time taken. The stored time taken, which is a measure of the length of time that a client will take to process an update to an object, is used in the calculation of the time value that is included with an update. The client receives the update and the time value, which is an indication of the length of time before the next update arrives. The client can use this information to decide on the appropriate course of action, whether to wait for another update, or whether to act on the current update.

### BRIEF DESCRIPTION OF THE DRAWINGS

Embodiments of the present invention will now be described, by way of example only, with reference to the accompanying drawings, wherein:

FIG. 1 is a schematic diagram of a communication system comprising a server and a client;

FIG. 2 is a schematic diagram of a queue;

FIG. 3 is a schematic diagram of a graphical application comprising four screens; and

FIG. 4 is a schematic diagram of the graphical application of FIG. 2.

### DETAILED DESCRIPTION

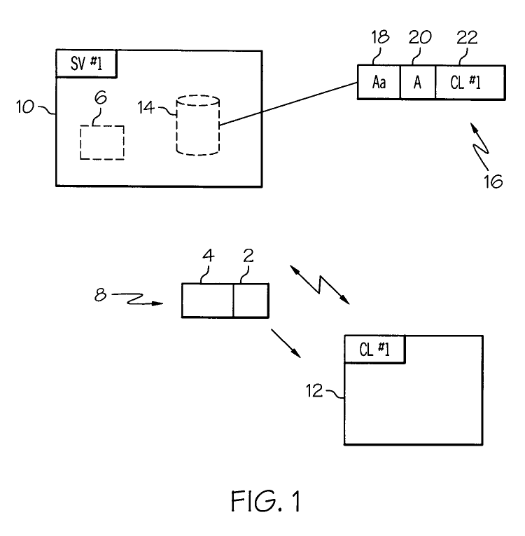

FIG. 1 shows a server 10 and a client 12. The server 10 and client 12 are in communication. Periodically, the server 10 will send a notification 8 to the client 12. The server 10 includes a processor 6 for generating the notification 8. The notification 8 comprises two different parts, a content portion 4 and a notification availability indicator 2. The content portion 4 may relate to a specific object in which the client 12 is interested, and may comprise details of an update for that object. The notification availability indicator 2 may be a time value, which relates to a calculation, which may be either an estimation or an exact figure, of the time before another notification is to be sent to the client 12. This is discussed in more detail below.

The server 10 also comprises a storage device 14 that stores an object interest registration 16. The server 10 will store multiple registrations 16 relating to many different objects. The client 12 transmits the object interest registration 16 to the server 10 to register its interest in a particular object.

The object interest registration 16 has three components: an object identifier 18, a correlation identifier 20, and a client identifier 22. The object identifier 18, which is “Aa” in the example of FIG. 1, is the object for which the client 12 wishes to receive updates. The object “Aa” is a component of a display device. When the client 12 registers an interest in an object with the server 10, the client 12 includes a correlation identifier 20 within the object interest registration 16. This identifier 20 can be of any type; it is used to identify groups of related objects. In the case of the object interest registration 16 shown in FIG. 1, the identifier 20 is “A”, indicating that the object “Aa” belongs to the display “A”. The final part of the object interest registration 16 is the client identifier 20, being the client device “CL #1”.

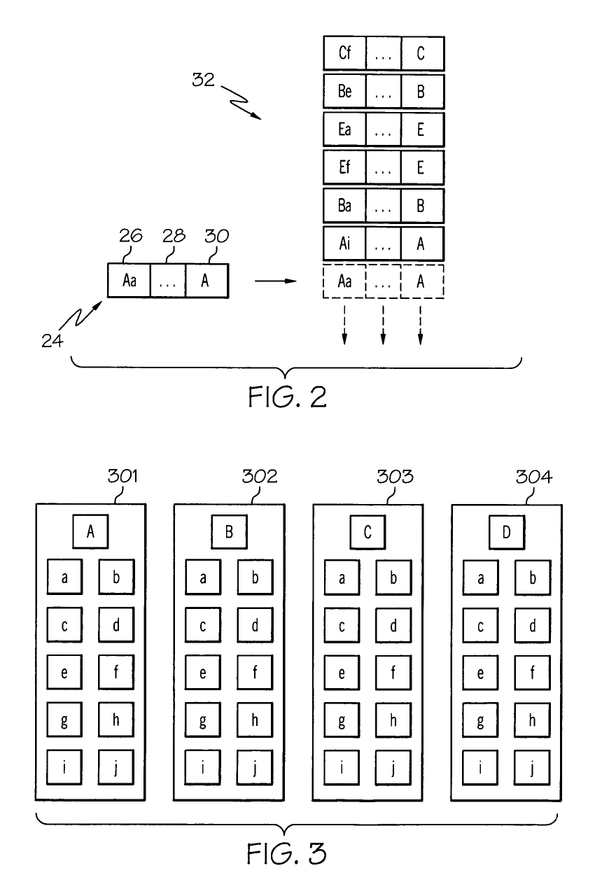

When the server 10 wishes to inform a client 12 of an update to an object, the server 10 does not notify clients directly. Instead, the server 10 creates an update notification 24, shown in FIG. 2, which represents the notification of the change to that client 12. This update notification 24 comprises an object identifier 26, an update request 28, and a correlation identifier 30. The object identifier 26 in FIG. 2 is the object “Aa”, and the correlation identifier 30 is the group “A” to which the object “Aa” belongs. The update request 28 will contain the details of the changes to the object “Aa” that form the content of the update.

Following the creation of the update notification 24, the server 10 adds the update notification 24 to a queue 32 of such notifications, which may relate to a variety of different objects. This queue 32 will be being added to continuously by the server 10, each and every time the server 10 receives information or itself generates information that an object is to be updated.

Once a new update notification 24 has been added to the queue 32, a separate “notification” thread instantiated by the server 10 reads the update notification 24 off the queue 32. For each update notification 24, the notification thread scans other notifications on the queue 32 looking for the first update notification 24 with the same correlation identifier 30. Once an update notification 24 with the same correlation identifier 30 has been found, the server 10 notes the position of this second update notification 24 on the queue 32 and stops searching.

At this point, the server 10 notifies the client 12 that the object has changed. As part of the notification 8, the server 10 informs the client 12 of a time value 2, which corresponds to the predicted time before the next notification. This time value may be calculated by multiplying the position in the queue 32 of the next update notification 24 with the same correlation identifier 30 by the average time it takes for the client 12 to process an update.

The average time taken by the client 12 to process an update can be a stored value for that client 12, it can be an estimated value, or it can be calculated on a regular basis for a client 12. If, during the scan of the queue 32 no future update notifications were queued with the same correlation identifier, the “predicted time” value will indicate to the client that no more updates are pending.

Once the client 12 receives the notification comprising an update request 4 and the time value 2, the client 12 decides, on the basis of the “predicted time till the next notification” parameter, whether it is worth acting on the information by, for example, executing the update. Alternatively, the client 12 can wait for any subsequent update requests for that same object and apply the updates all at the same time, with the corresponding saving in resources. In any case, the client 12 may send an acknowledgement of receipt back to the server 10.

The average time it takes for the client 12 to process an update can be calculated by the server 10 while the updating process is running. The server 10 measures the time taken for the acknowledgement of receipt to come back from the client 12. This may be achieved by starting an internal timer, before the server 10 sends out a notification to a client 12. When the client 12 returns control to the server 10, the server stops the timer, and the time taken is recorded and used to determine the average time for future notifications.

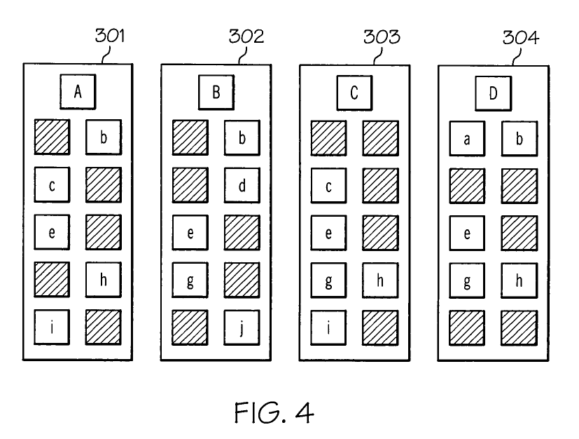

FIG. 3 illustrates a graphical application scenario, with the client object being one that displays status information on four systems 301 through 304, and that each system is made up of ten components a through j. FIG. 4 shows the screen with the state of each component (solid=stopped, letter=started).

Information on all forty components in this system may be provided by the server 10. Importantly, the algorithm used for updating the screen may be such that only the representation of an entire system can be refreshed; change in a single component (a to j) means that the display for the entire system (301, 302, 303, or 304) needs to be refreshed. For example, a change in the run-state of system 303's component h means that the display for system 303 needs to be refreshed.

The client 12 registers for changes to all ten components of system 301 using the same correlation identifier ‘A’. Similarly, the client 12 also registers for changes to components of the other systems 302, 303, and 304 using the correlation identifiers ‘B’, ‘C’, and ‘D’, respectively.

To illustrate the invention, an example will be described with reference to an event occurring which means that all of the components in systems 301 and 302 are now stopped. The server application is told (by whatever means) that the run-states of components Ab, Ac, Ae, Ah, Ai, Bb, Bd, Be, Bg and Bj are now ‘stopped’.

In a prior art system, a server would send ten notifications to a client. The client would receive the first notification (that is, for component Ab), update the display for system 301 and return. It would then receive the second notification (Ac) and update the display for system 301 again and return. Once all notifications have been processed, the display would have been updated ten times: five times for both the systems 301 and 302. This is inefficient, and would probably cause the display to flicker while all ten screen refreshes occur.

However, in the improved methodology, when an event occurs, the server 10 receives the ten messages stating that the state of ten components is now ‘stopped’. As discussed above, the server 10 converts these messages into update notifications and places them on an internal queue.

The server 10 reads the first notification from the queue (“Notify graphical application client that Ab has changed”). The notification thread reads ahead on the queue and discovers that at queue position 1 is another notification with the same correlation identifier (that is, the notification for Ac). So, the notification thread warns the client that another notification is about to occur in around 1×50 milliseconds, as this is the first update, the thread decides that 50 milliseconds is the default “average time for notifications”, including with its notification, the notification availability indicator which constitutes the time value of 50 milliseconds.

The client 12 will receives this first notification. As it is told that another notification is about to occur in a relatively short space of time, the client 12 will decide not to update the screen and simply return control to the notification thread. Similarly, the notification thread sends notifications to the client 12 for components Ac, Ae and Ah, all of which are also ignored by the client 12, as it is told that another notification for system 301 is imminent.

When the notification for component ‘Ai’ is read from the queue, the notification thread scans the queue for other notifications with the correlation identifier ‘A’. Even though the queue still contains five more notifications (Bb, Bd, Be, Bg and Bj), none of these share the correlation identifier ‘A’ and so, when the notification is sent to the client, it is told that no more updates are enqueued and so the screen can be updated for system 301.

Note that the client 12 has the freedom to decide to update the display for system 301 upon receipt of any of the five notifications relating to it. Otherwise, a scenario containing a constant stream of events may lead to the screen never being updated. By following the method described here, the number of screen updates in this scenario is reduced from ten down to two, one for each of the systems 301 and 302. This will improve the performance of this application considerably.

What is claimed is:

1. A communication method comprising generating a notification, the notification comprising a content portion and a notification availability indicator; transmitting the notification from a server to a client; and receiving the notification at the client.

2. The method according to claim 1, wherein the notification availability indicator comprises a time value.

3. The method according to claim 1, wherein the notification availability indicator comprises an indicator indicating that further notifications are to be transmitted.

4. The method according to claim 1, wherein the notification availability indicator comprises an integer indicating the number of further notifications to be transmitted.

5. The method according to claim 1, wherein the content portion comprises reference to a specific object.

6. The method according to claim 5, wherein the content portion includes an update request for the specific object.

7. The method according to claim 1, further comprising receiving an object interest registration from the client.

8. The method according to claim 1, further comprising receiving from the client an acknowledgement of receipt of the notification.

9. The method according to claim 8, further comprising measuring the time taken from the transmission of the notification to the receipt of the acknowledgement of receipt of the notification.

10. A communication system, comprising: a server and a client, the server comprising a processor arranged to generate a notification, the notification comprising a content portion and a notification availability indicator, and a communication interface for transmitting the notification to the client, the client comprising a communication interface for receiving the notification.

11. The system according to claim 10, wherein the notification availability indicator comprises a time value.

12. The system according to claim 10, wherein the notification availability indicator comprises an indicator indicating that further notifications are to be transmitted.

13. The system according to claim 10, wherein the notification availability indicator comprises an integer indicating the number of further notifications to be transmitted.

14. The system according to claim 10, wherein the content portion comprises reference to a specific object.

15. The system according to claim 14, wherein the content portion includes an update request for the specific object.

16. The system according to claim 10, wherein the client is arranged to transmit an object interest registration to the server.

17. The system according to claim 10, wherein the client is further arranged to transmit an acknowledgement of receipt of the notification to the server.

18. The system according to claim 17, wherein the processor of the server is further arranged to measure the time taken from the transmission of the notification to the receipt of the acknowledgement of receipt of the notification.

19. A computer program product for controlling a communication system, the computer program product comprising a computer readable medium having computer readable program code tangibly embedded therein, the computer readable program code comprising: computer readable program code configured to generate a notification comprising a content portion and a notification availability indicator; computer readable program code configured to transmit the notification from a server to a client; and computer readable program code configured to receive the notification at the client.

20. The computer program product according to claim 19, wherein the notification availability indicator comprises at least one of the following: a time value, an indicator indicating that further notifications are to be transmitted, and an integer indicating the number of further notifications to be transmitted.
